(19) United States
(12) Patent Application Publication
(10) Pub. No.: US 2025/0371320 A1
(43) Pub. Date: Dec. 4, 2025

(54) NEURAL NETWORKS WITH LEARNED AUGMENTED RESIDUAL LAYERS

(71) Applicant: Google LLC, Mountain View, CA (US)

(72) Inventors: Gaurav Menghani, Santa Clara, CA (US); Shanmugasundaram Ravikumar, Piedmont, CA (US); Sanjiv Kumar, Jericho, NY (US)

(21) Appl. No.: 19/228,492

(22) Filed: Jun. 4, 2025

Related U.S. Application Data
(60) Provisional application No. 63/656,059, filed on Jun. 4, 2024.

(51) Int. Cl. G06N 3/0464; G06N 3/044

(52) U.S. Cl. CPC G06N 3/0464; G06N 3/044

(57) ABSTRACT

Methods, systems, and apparatuses, including computer programs encoded on computer storage media, for processing a network input using a neural network to generate a network output for the network input. That is, by using a neural network that includes a sequence of layer blocks that, for each layer block, processes a block input for the particular layer block through a learned non-linear transformation to generate an initial block output for the particular layer block and combines the initial block output for the particular layer block with at least the block input in accordance with one or more learned parameters to generate the block output for the particular layer block, the described techniques maximize the neural network performance for a given neural network footprint.

### CROSS-REFERENCE TO RELATED APPLICATIONS

This application claims priority of U.S. Provisional Application Ser. No. 63/656,059, filed Jun. 4, 2024. The contents of the prior application is incorporated herein by reference in its entirety.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that processes a network input using a neural network to generate a network output for the network input.

Particular embodiments of the subject matter described in this specification can be implemented so as to realize one or more of the following advantages.

Neural networks are capable of performing many useful machine learning (ML) tasks, such as image classification, (time series) forecasting of event(s), robotic agent control, natural language generation (e.g., computer code generation or editing tasks, text generation or editing tasks), image generation (e.g., image editing tasks, image understanding tasks), and so on. It is often the case that the more complex the ML task, the more complex the neural network's architecture needs to be in order to perform the task well.

While increasing the complexity of a neural network through conventional modifications (e.g., increasing the number of layer blocks, i.e., the number of collections of one or more neural network layers, or increasing the number of layers within layer blocks) can enable the neural network to perform more complex tasks, it also introduces an increased compute resource requirement to use the neural network (i.e., introduces a larger neural network footprint, e.g., increased number of parameters, increased train time, increased inference latency, increased resident memory size, increased peak memory consumption, and so on). Worse yet, sometimes the increased footprint only affords a marginal increase in performance and limits the practical use of the neural network for performing an ML task.

For example, for a ML task that necessitates an increased neural network complexity, the increase in neural network complexity can be achieved through an increase of the number of layer blocks in the neural network. But increasing the number of layer blocks may not improve the neural network ML task performance much and may make training the neural network, serving the neural network, or both prohibitively computationally expensive. For real-world real-time applications of the neural network performing the ML task (e.g., robotic agent control, e.g., autonomous vehicle navigation) the increased footprint associated with the increase in number of layer blocks can be detrimental and a barrier for practically performing the ML task.

This specification describes a system that can address the aforementioned challenges. That is, this specification describes a system that can obtain, then process a network input using a neural network to generate a network output for the network input, where the neural network includes a sequence of layer blocks and one or more of the layer blocks include a learned augmented residual layer (LAuReL). The system can use a learned augmented residual layer (LAuReL) to combine an initial block output for a particular layer block with at least the block input in accordance with one or more learned parameters to generate a block output for the particular layer block. That is, to process a respective block input for a layer block using the layer block to generate a block output for the layer block, the system, for a particular layer block, processes the block input for the particular layer block through a learned non-linear transformation to generate an initial block output for the particular layer block. Afterward, the system can combine the initial block output for the particular layer block with at least the block input in accordance with one or more learned parameters to generate the block output for the particular layer block (i.e., the system can use a LAuReL).

As a result of employing the described techniques, the system improves the pareto-frontier of neural network performance vs footprint. That is, the system maximizes the performance of the neural network for a given neural network footprint (e.g., for a fixed number of layer blocks or layers) when processing a network input to generate a network output. By processing block inputs through both learned non-linear transformations and combinations in accordance with learned parameter(s) the system can divide non-linear and linear learning. That is, the combination of the initial block output for the particular layer block with at least the block input in accordance with learned parameter(s) to generate the block output for the particular layer block abstracts learning linear components from learning non-linear components, facilitating the non-linear transformation to more easily learn the non-linear components. In other words, the system maximizes the performance of the neural network for every learned parameter(s), and, consequently, the system is capable of greater ML task performance for smaller neural network footprints.

For example, the described techniques can be used to improve the image classification performance of ResNet-50 on the ImageNet-1K dataset (i.e., the accuracy@1 metric, i.e., how often the model's top class prediction is correct) for a fixed footprint. In particular, while adding an additional layer to each layer block of the ResNet-50 neural network or using the described techniques to replace residual connection layers in each layer block of the ResNet-50 neural network both improve the accuracy@1 of ResNet-50 by 0.25%, using the described techniques requires 38% less parameters than adding an additional layer does and, therefore, the described techniques maximize the performance of the neural network for a given footprint.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows a neural network system.

FIG. 2 is a flow diagram of an example process for processing the network input using a neural network to generate a network output for the network input.

FIG. 3 is a flow diagram of an example process for processing a respective block input for the layer block using the layer block to generate a block output for the layer block.

FIG. 4 is a flow diagram of an example process for training a neural network.

FIG. 5 is an example of the performance of the described techniques.

FIG. 6 is an example of the performance of the described techniques.

### DETAILED DESCRIPTION

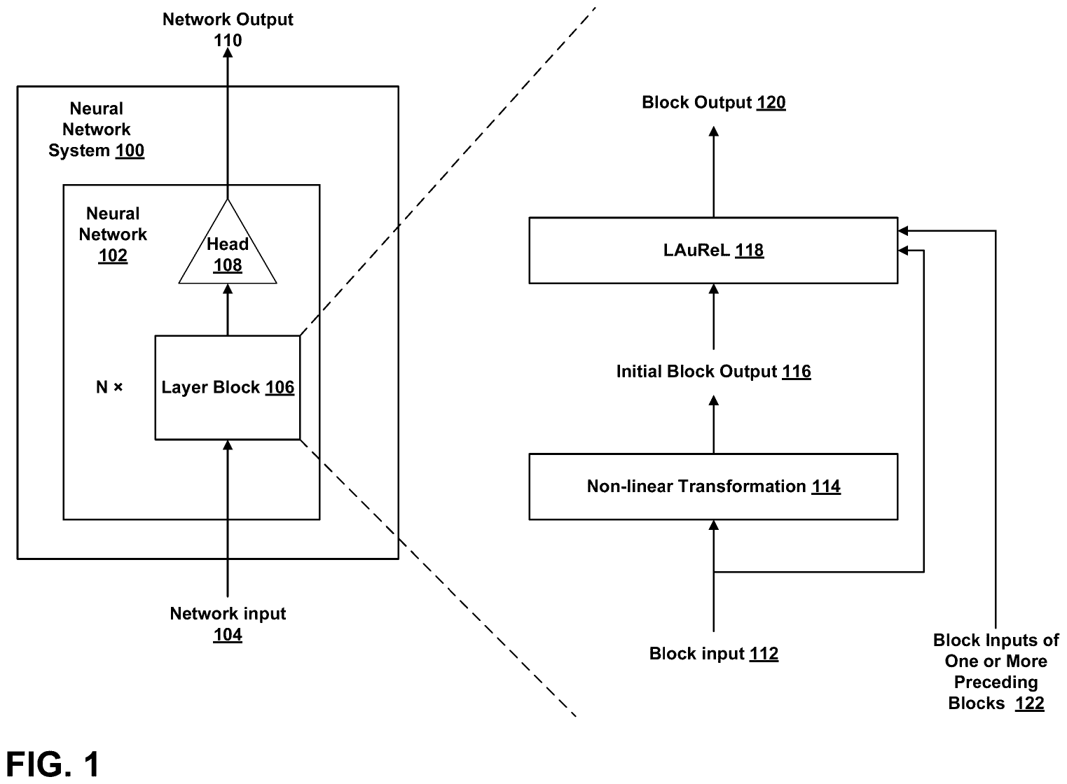

FIG. 1 shows an example neural network system 100. The neural network system 100 is an example of a system implemented as computer programs on one or more computers in one or more locations, in which the systems, components, and techniques described below can be implemented.

In particular, the system 100 processes a network input 104 using a neural network 102 to generate a network output 110 for the network input 104.

Generally, the neural network 102 includes a sequence of layer blocks 106. A “layer block” as used in this specification is a collection of one or more neural network layers.

As part of processing the network input 104, for each layer block 106, the system 100 processes a respective block input 112 for the layer block 106 using the layer block 106 to generate a block output 120 for the layer block 106.

For the first layer block 106 in the sequence, the respective block input 112 is the network input 104 (or an input that has been generated from the network input 104 by another component of the neural network 102) and, for each subsequent block 106 in the sequence, the respective block input 112 is the block output 120 for the preceding layer block 106 in the sequence. For example, the first layer block 106 in the sequence can be an embedding subnetwork of the neural network 102 or a “backbone” of the neural network 102 that processes the network input 104 to generate an embedded or encoded representation of the network input 102.

Generally, some or all of the layer blocks 106 in the sequence have a learned augmented residual layer (LAuReL) 118. More specifically, for a particular layer block 106 that has a LAuReL 118, to generate the block output 120 for the particular layer block 106, the system 100 processes the block input 112 for the particular layer block 106 through a learned non-linear transformation 114 to generate an initial block output 116 for the particular layer block 106 and then uses the LAuReL 118 to combine the initial block output 116 for the particular layer block 106 with at least the block input 112 in accordance with one or more learned parameters to generate the block output 120 for the particular layer block 106.

A “learned” transformation is one that has parameters that have been learned (adjusted) during the training of the neural network 102. Similarly, a learned parameter is a parameter whose value has been adjusted during the training of the neural network 102. As a particular example, the one or more learned parameters of the LAuReL 118 and the parameters of the learned non-linear transformation 114 can have been updated using gradient-based updates during the training of the neural network 102, i.e., based on computing gradients with respect to the parameters of a loss function for the training.

Further details of training the neural network are described below.

The non-linear transformation 114 can be any of a variety of learned transformation, e.g., can include one or more of: attention heads, an MLP, one or more convolutional layers, one or more recurrent layers and so on.

More generally, the LAuReL 118 can be inserted in place of a conventional residual connection in any layer block within any appropriate neural network architecture that includes a sequence of layer blocks. In other words, the sequence of layer blocks 106 can be included as part of any appropriate neural network that includes a sequence of layer blocks as part of their architecture. Examples of such neural networks include convolutional neural networks, encoder-only Transformer neural networks, decoder-only Transformer neural networks, encoder-decoder Transformer neural networks, state space models, recurrent neural networks, residual fully-connected neural networks and so on.

In some cases, the system uses the LAuRel 118 to combine the initial block output 116 for the particular layer block with the block input 112 and respective block inputs of one or more preceding blocks 122 that precede the particular layer block 106 in the sequence in accordance with the one or more learned parameters to generate the block output 120 for the particular layer block 106.

In some implementations, the neural network 102 includes a neural network head 108 that the system 100 uses to generate the network output 110. That is, the system 100 can use the output neural network head 108 to process the block output 120 of the last layer block 106 in the sequence of layer blocks 106 to enforce a particular dimension for the network output 110 or to transform the block output 120 based on the ML task the network output 110 serves.

The neural network 102 can generally be configured to perform any of a variety of tasks.

The neural network system 100 can perform any kind of machine learning task, i.e., can be configured to receive any kind of digital data input (i.e., network input 104) and to generate any kind of score, classification, or regression output (i.e., network output 110) based on the input.

In some cases, the neural network system 100 is configured to perform an image processing task, i.e., receive an input image 104 and to process the input image 104, i.e., to process intensity values of the pixels of the image, to generate a network output 110 for the input image. For example, the task may be image classification and the output 110 generated by the neural network 102 for a given image may be scores for each of a set of object categories, with each score representing an estimated likelihood that the image contains an image of an object belonging to the category. As another example, the task can be image embedding generation and the output 110 generated by the neural network 102 can be a numeric embedding of the input image 104. As yet another example, the task can be object detection and the output 110 generated by the neural network 102 can identify locations in the input image 104 at which particular types of objects are depicted. As yet another example, the task can be image segmentation and the output 110 generated by the neural network 102 can assign each pixel of the input image 104 to a category from a set of categories. As another example, the task can be a depth prediction task. In a depth prediction task, the output 110 generated by the neural network 102 identifies, for each pixel in the image, a predicted depth of the scene at the pixel. As yet another example, the task can be a surface normal prediction task. In a surface normal prediction task, the output 110 generated by the neural network 102 identifies, for each pixel in the image, a predicted surface normal of the scene at the pixel.

As another example, the neural network 102 can be configured to perform a video processing task, where the neural network 102 receives an input video 104 that includes a sequence of input images and processes the input images, i.e., process the intensity values of the pixels of the images, to generate a network output 110 for the input video 104. For example, the network output can be a classification output that includes a respective score for each of multiple categories, where the categories represent, e.g., topics of the video, object categories, or action categories that each correspond to possible actions that may be being performed by entities in the video, and each score represents an estimated likelihood that the video belongs to the category. As another example, the network output 110 can identify optical flow between pixels of the images in the video. As another example, the network output 110 can be one or more predicted images that are predicted to follow the last image in the sequence.

As another example, if the inputs 104 to the neural network system 100 are Internet resources (e.g., web pages), documents, or portions of documents or features extracted from Internet resources, documents, or portions of documents, the task can be to classify the resource or document, i.e., the output 110 generated by the neural network system 100 for a given Internet resource, document, or portion of a document may be a score for each of a set of topics, with each score representing an estimated likelihood that the Internet resource, document, or document portion is about the topic.

As another example, if the inputs 104 to the neural network system 100 are features of an impression context for a particular advertisement, the output 110 generated by the neural network system 100 may be a score that represents an estimated likelihood that the particular advertisement will be clicked on.

As another example, if the inputs 104 to the neural network system 100 are features of a personalized recommendation for a user, e.g., features characterizing the context for the recommendation, e.g., features characterizing previous actions taken by the user, the output 110 generated by the neural network system 100 may be a score for each of a set of content items, with each score representing an estimated likelihood that the user will respond favorably to being recommended the content item.

As one example, the task may be a neural machine translation task. For example, if the input 104 to the neural network system 100 is a sequence of text, e.g., a sequence of words, phrases, characters, or word pieces, in one language, the output 110 generated by the neural network system 100 may be a translation of the sequence of text into another language, i.e., a sequence of text in the other language that is a translation of the input sequence of text. As a particular example, the task may be a multi-lingual machine translation task, where a single neural network 102 is configured to translate between multiple different source language-target language pairs. In this example, the source language text may be augmented with an identifier that indicates the target language into which the neural network system 100 should translate the source language text.

As another example, the task may be an audio processing task. For example, if the input 104 to the neural network system 100 is a sequence representing a spoken utterance, e.g., a spectrogram or a waveform or features of the spectrogram or waveform, the output 104 generated by the neural network system 100 may be a piece of text that is a transcript for the utterance. As another example, if the input 104 to the neural network system 100 is a sequence representing a spoken utterance, the output 110 generated by the neural network system 100 can indicate whether a particular word or phrase (“hotword”) was spoken in the utterance. As another example, if the input 100 to the neural network system 100 is a sequence representing a spoken utterance, the output 110 generated by the neural network system 102 can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input 104 is text in a natural language or features of text in a natural language and the network output 110 is a spectrogram, a waveform, or other data defining audio of the text being spoken in the natural language.

As another example, the task can be a health prediction task, where the input 104 is a sequence derived from electronic health record data for a patient and the output 110 is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the system 100 receives a conditioning input 104 and generates as output 110 a sequence of text. For example, the conditioning input 104 can be another sequence of text, e.g., so that the output sequence is a completion of the input sequence of text, a response to a question posed in the input sequence, or a sequence of text that is about a topic specified by the first sequence of text. As another example, the input 104 to the text generation task can be an input other than text, e.g., an image, and the output sequence can be text that describes the input.

As another example, the task can be an image generation task, where the input 104 is a conditioning input and the output 110 is a sequence of intensity values for the pixels of an image.

As another example, the task can be a computer vision task, where the input 104 is an image or a point cloud and the output 110 is a computer vision output for the image or point cloud, e.g., a classification output that includes a respective score for each of a plurality of categories, with each score representing the likelihood that the image or point cloud includes an object belonging to the category. When the input 104 is an image or point cloud, the neural network system 100 can include an embedding subnetwork that generates a respective embedding for each multiple patches of the image or point cloud, and the input to the first block of the neural network system 100 can be a sequence that includes the respective embeddings (and, optionally, one or more additional embeddings, e.g., at a predetermined position that will later be used to generate the output). Each patch includes the intensity values of the pixels in a different region of the input image.

As another example, the task can be an agent control task, where the input 104 is a sequence of observations or other data characterizing states of an environment and the output 110 defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input 104 is a sequence representing a fragment of a DNA sequence or other molecule sequence and the output 110 is either an embedding of the fragment for use in a downstream task, e.g., by making use of an unsupervised learning technique on a data set of DNA sequence fragments, or an output 110 for the downstream task. Examples of downstream tasks include promoter site prediction, methylation analysis, predicting functional effects of non-coding variants, and so on.

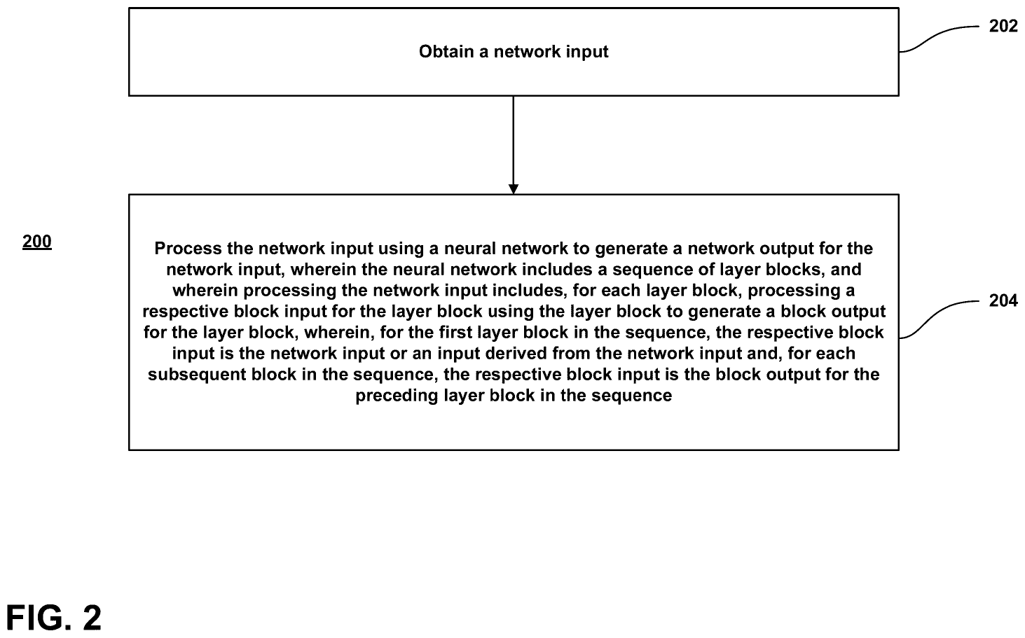

FIG. 2 is a flow diagram of an example process 200 for processing the network input using a neural network to generate a network output for the network input. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system obtains a network input (step 202).

Generally, the network input can include any type of input data (e.g., numeric values, categorical values, natural language text data, audio data, image data, video data, any combination of these data, and so on) as is appropriate for the neural network and the machine learning task the system performs.

For example, the network input can be an input sequence, e.g., a sequence of natural language text, image pixels or patches, video frames, video frame patches, audio waveform time windows, spectrogram amplitude frequency-time windows, any combination of these elements, and so on.

As described above, in some cases the system processes the network input with an embedding subnetwork of the neural network to generate an embedded or encoded representation of the network input.

For example, the system can represent a network input that is an input sequence as a sequence of tokens, e.g., sequence of text tokens, e.g., words, word pieces, bytes, characters, numbers, punctuation, or other text symbols and tokens representing other types of data, e.g., image data, video data, audio data, and so on. Then, the system can map this sequence of tokens to a corresponding encoding (e.g., a sequence of embeddings) using the embedding subnetwork.

Generally, the system can obtain the network input from any of a variety of sources, e.g., a user or another system.

For example, the neural network system can be deployed on a user device and the system can receive the network input for performing a ML task at the user device, e.g., from a user of the device.

For example, the neural network system can be deployed on a user smartphone and the system can receive the network input for performing a ML task (e.g., a natural language processing or understanding task) from a user through the smartphone (e.g., through the user creating the network input, e.g., typing a network input that is natural language text input on the smartphone and the system receiving the network input from the smartphone).

As another example, the neural network system can be deployed on a user laptop and the system can receive the network input for performing a ML task (e.g., an image editing task) from a user through the laptop (e.g., through the user creating the network input, e.g., uploading an input image onto the laptop and typing on the laptop keyboard natural language instructions of how to edit the input image).

As another example, the system can receive a network input from a user using a user device over a network, e.g., by establishing a network connection with the user device. For example, the network can be a cloud-based network, the internet, or a local network. For example, the neural network system on a computer server can receive a network input from a user using a user device (e.g., natural language text input generated by a user using a smartphone) over a network (e.g., LTE internet connection).

The system processes the network input using a neural network to generate a network output for the network input (step 204).

The neural network can be any of a variety of neural networks that the system can use to process a network input to generate a network output for the network input and can have any of a variety of neural network architectures. That is, the neural network can have any appropriate architecture in any appropriate configuration that processes network input to generate network output, including fully connected layers, convolution layers, recurrent layers, attention-based layers, and so on, as is appropriate.

Generally, the network output can include any type of output data (e.g., numeric values, categorical values, natural language text data, audio data, image data, video data, any combination of these data, and so on) as is appropriate for the neural network and the machine learning task the system performs.

Generally, the neural network includes a sequence of layer blocks, and processing the network input includes, for each layer block, processing a respective block input for the layer block using the layer block to generate a block output for the layer block. For the first layer block in the sequence, the respective block input is the network input or an input derived from the network input and, for each subsequent block in the sequence, the respective block input is the block output for the preceding layer block in the sequence.

Further details of processing a respective block input for the layer block using the layer block to generate a block output for the layer block are described below.

In some implementations, the system processes the block output for a last layer block in the sequence using an output neural network head to generate the network output. The output neural network head can process the block output to enforce particular structure for the network output (e.g., enforce a particular shape or dimensions for the network output) or to transform the block output based on the ML task the network output corresponds to.

For example, the output neural network head can be for a classification task (e.g., image classification, video classification, and so on) and the system can use the neural network head to enforce the network output to have a score for each possible class. Additionally, the output neural network head can include a softmax function to transform the scores for each class to generate a probability for each class.

As another example, the output neural network head can be for a regression task (e.g., predicting the amount of rainfall for a geographic region) and the system uses the neural network head to concatenate multiple layer block outputs, perform average pooling of those outputs, and then linearly transform the averaged pooled outputs to generate a single value that represents the predicted amount of rainfall.

In some implementations, the system provides the network output to a user or another system. For example, the system can provide the network output for presentation to a user of the user device, e.g., a user the system received the network input from, or to another software application running on the user device.

For example, the network output can be an output sequence, e.g., an output sequence of tokens generated by the system by using the neural network to autoregressively sample tokens from the neural network's probability distribution over tokens of a vocabulary, conditioned on previously generated tokens and the network input, until a stopping criterion is met (e.g., generating an output sequence of fixed length, or generating and ‘end of sequence’ token). For example, the output sequence can be a sequence of text tokens, tokens representing other types of data, e.g., image data, video data, audio data, and so on, or any combination of types of tokens. At the same time, the output sequence of tokens of the network output can be detokenized (i.e., converting a sequence of tokens to natural language text, image, video, audio, any combination of these, and so on) and presented to the user, e.g., through a device display screen and speaker, e.g., displaying natural language text, image, video, playing audio, or any combination of these.

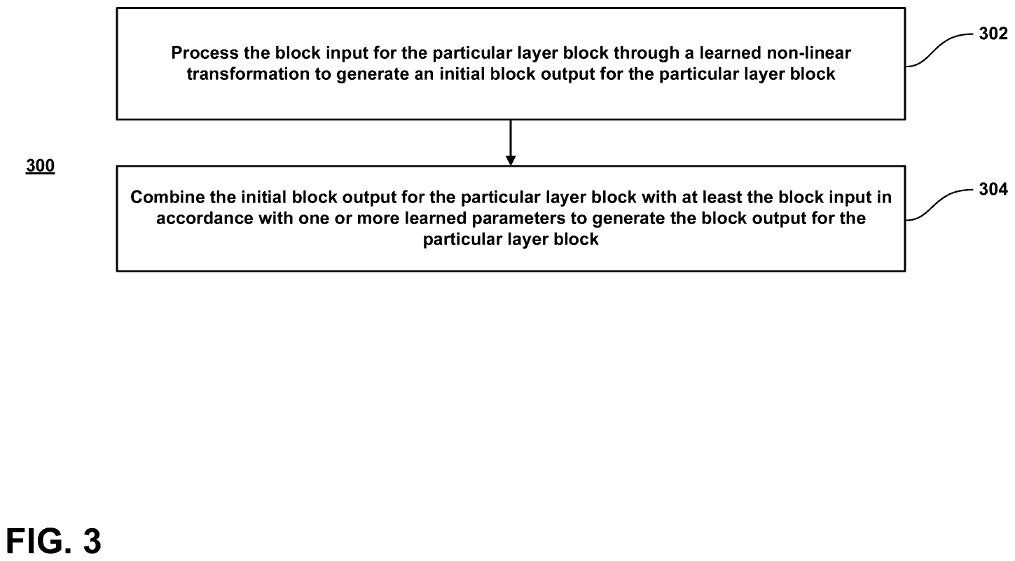

FIG. 3 is a flow diagram of an example process 300 for processing a respective block input for the layer block using the layer block to generate a block output for the layer block. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system processes the block input for the particular layer block through a learned non-linear transformation to generate an initial block output for the particular layer block (step 302).

The learned non-linear transformation can include any of a variety of neural network layers that facilitate learning complex non-linear relationships between block inputs and initial block outputs. As described above, the non-linear transformation can include, for example, one or more of a multi-layer perceptron (MLP), one or more convolutional layers, one or more recurrent layers, one or more attention heads, and so on.

Generally, for cases in which the non-linear transformation includes one or more attention heads, the system can use the attention heads to apply any attention mechanism.

For example, sometimes, for cases in which the non-linear transformation includes one or more attention heads, the system can use the one or more attentions heads to apply self-attention. That is, the system can use the one or more of the attention heads to apply the attention mechanism referred to as “self-attention” for which the queries, keys, and values of the attention mechanism are all based on the block input.

As another example, other times, for cases in which the non-linear transformation includes one or more attention heads, the system can use the one or more attentions heads to apply cross-attention. That is, the system can use the one or more of the attention head uses the attention mechanism referred to as “cross-attention” for which the queries are based on the block input, but the keys and values are based on a different input for the attention mechanism.

The system combines the initial block output for the particular layer block with at least the block input in accordance with one or more learned parameters to generate the block output for the particular layer block (step 304).

In some cases, the one or more learned parameters define respective weights for the block input and for the initial block output and, and the system determines a weighted sum of the initial block output for the particular layer block and the block input in accordance with the respective weights when combining the initial block output for the particular layer block with at least the block input in accordance with one or more learned parameters to generate the block output for the particular layer block.

Further in some cases, the one or more parameters include a first parameter that defines the respective weight for the block input and a second parameter that defines the respective weight for the initial block output.

As an example, generating the block output can be expressed by the following equation

$${x}_{i + 1} = α f ( {x}_{i} ) + β {x}_{i}$$

where xᵢ is the block input for the particular layer block (i.e., the i^{th} block), xᵢ₊₁ is the block output (i.e., the i+1 block input if the i+1 block exists), f(xᵢ) represents the initial block output, f(⋅) represents a learned non-linear transformation to generate an initial block output for the particular layer block, and the one or more learned parameters that define respective weights are, for the block input, β and, for the initial block output, α.

In some cases, the system can use a normalization function such as the softmax or sigmoid function to prevent one or more learned parameters from growing unbounded when the system trains the neural network, e.g., the β and α parameters of the previous example equation.

In some cases, the one or more parameters are a single parameter that defines both the respective weight for the block input and the respective weight for the initial block output.

For example, the single parameter δ can determine the respective weight for the block input, e.g., β of the previous example equation, and the respective weight for the initial block output, e.g., α of the previous example equation, using a function like sigmoid (i.e., σ(⋅)). For example, for the previous example equation, the parameters a, B can be defined in terms of this single parameter δ to create a convex combination as α=σ(δ) and β=1−σ(δ). The first parameter that defines the respective weight for the block input and a second parameter that defines the respective weight for the initial block output (e.g., the example δ parameter or the β and α parameters described above) contribute a negligible constant number of parameters (1 or 2) and a negligible constant additional latency when processing block inputs to generate block outputs relative to a baseline of computing xᵢ₊₁=f(xᵢ)+xᵢ.

In some cases, the one or more learned parameters define a linear transformation, and the system determines a combination of (i) the initial block output and (ii) an output of the linear transformation applied to the block input when combining the initial block output for the particular layer block with at least the block input in accordance with one or more learned parameters to generate the block output for the particular layer block.

Further in some cases, the combination is a sum.

In some cases, the linear transformation is a product between a weight matrix and the block input, and the one or more learned parameters define the entries of the weight matrix.

For example, generating the block output can be expressed by the following equation

$${x}_{i + 1} = f ( {x}_{i} ) + {Wx}_{i}$$

where all terms retain their definitions from the above equations, and where W is the weight matrix for which one or more learned parameters define the entries, and W xᵢ is the output of the linear transformation applied to the block input and is the product between a weight matrix and the block input.

In some cases, the linear transformation is a sum of (i) a product between a weight matrix and the block input and (ii) the block input, where the weight matrix is a low rank matrix that is a product between a first matrix and a second matrix, and the one or more learned parameters include the entries of the first and second matrices.

For example, generating the block output can be expressed by the following equation

$${x}_{i + 1} = f ( {x}_{i} ) + {ABx}_{i} + {x}_{i}$$

where all terms retain their definitions from the above equations, and where A and B^{T} are D×r matrices that are the first low rank matrix and second low rank matrix respectively (where D and r denote dimension sizes, D represents the total number of elements of xᵢ, and r<<D), BAxᵢ is the product between a weight matrix and the block input, and BAxᵢ+xᵢ is the output of the linear transformation. The learnable parameters of both A and B that define the weight matrix determined by BA is associated with 2rD additional parameters and an extra time complexity that scales as rD² (i.e., scales a matrix multiplication of BA) relative to a baseline of computing xᵢ₊₁=f(xᵢ)+xᵢ.

In some cases, the system combines the initial block output for the particular layer block with the block input and respective block inputs of one or more preceding blocks that precede the particular layer block in the sequence in accordance with the one or more learned parameters to generate the block output for the particular layer block when combining the initial block output for the particular layer block with at least the block input in accordance with one or more learned parameters to generate the block output for the particular layer block.

Further in some cases, the one or more learned parameters define respective weights to be applied to the initial block output, the block input, and the respective block inputs of one or more preceding blocks. Additionally, the system determines a weighted sum of (i) the initial block output for the particular layer block, (ii) a first input derived from the block input, and (iii) a respective second input derived from each of the respective block inputs of one or more preceding blocks in accordance with the respective weights when combining the initial block output for the particular layer block with the block input and respective block inputs of one or more preceding blocks that precede the particular layer block in the sequence in accordance with the one or more learned parameters to generate the block output for the particular layer block.

In some cases, the respective weight for the initial block output is a fixed value, and, further in other cases, this fixed value is one.

In some cases, the first input derived from the block input is the block input.

In some cases, the respective second input derived from each of the respective block inputs of one or more preceding blocks is the respective block input of the one or more preceding blocks.

In some cases, the first input derived from the block input is an output of a first linear transformation applied to the block input.

In some cases, the set of one or more learned parameters include parameters that define the first linear transformation.

In some cases, the respective second input derived from each of the respective block inputs of one or more preceding blocks is an output of a respective second linear transformation applied to the respective block input of the one or more preceding blocks.

In some cases, the set of one or more learned parameters comprises parameters that define the respective second linear transformations.

As an example, generating the block output can be expressed by the following equation

$${x}_{i + 1} = α f ( {x}_{i} ) + {\sum }_{j = 0}^{i - 1} {γ}_{j} \cdot {h}_{i , j} ( {x}_{j} ) + β {h}_{i} ( {x}_{i} )$$

where all terms retain their definitions from the above equations unless otherwise stated here. In particular, i is the index of the particular layer block; the index j runs overs the index of the one or more preceding blocks that precede the particular layer block (i.e., the i^{th} layer block in the example equation) in the sequence input; the parameters α, β, and γ are weights to be applied to the initial block output, the block input, and the respective block inputs of one or more preceding blocks; the first input derived from the block input (i.e., βhᵢ(xᵢ)) is an output of a first linear transformation hᵢ(⋅) applied to the block input; and the respective second input derived from each of the respective block inputs of one or more preceding blocks is an output of a respective second linear transformation h_{i,j}(⋅) applied to the respective block input inputs of the one or more preceding blocks

$$( i . e . , {\sum }_{j = 0}^{i - 1} {γ}_{j} \cdot {h}_{i , j} ( {x}_{j} ) ) ,$$

where the indices i, j for the second linear transformation are used to specify the linear transformation associated with a preceding block input of the j^{th} layer block used to generate the block output for the current particular i^{th} layer block. The learnable parameters γⱼ of the one or more preceding blocks generate k additional parameters (if there are k preceding layer blocks) and an extra time complexity that scales as kD (i.e., scales as k additions of the preceding layer block inputs, i.e., k times the D elements of each of the preceding layer block inputs) relative to a baseline of computing xᵢ₊₁=f(xᵢ)+xᵢ.

In some cases, the first linear transformation and the respective second linear transformations are each a linear transformation that is a sum of (i) a product between a respective weight matrix and a corresponding block input and (ii) the block input, and wherein the respective weight matrix is a low rank matrix that is a product between a respective first matrix and a respective second matrix.

As an example, generating the block output can be expressed by the following equation

$${x}_{i + 1} = α f ( {x}_{i} ) + {\sum }_{j = 0}^{i - 1} {γ}_{j} ( {A}_{i , j} {B}_{i , j} {x}_{j} + {x}_{j} ) + β ( {A}_{i} {B}_{i} {x}_{i} + {x}_{i} )$$

where all terms retain their definitions from the above equations unless otherwise stated here. In particular, where Ak Bk is a product between a respective first matrix and a respective second matrix that results in a low rank matrix that is a weight matrix, and the index k represents indices of i or i, j that specify the matrices associated with the first or any of the second linear transformations; and the terms (AᵢBᵢxᵢ+xᵢ) and (A_{i,j}B_{i,j}xⱼ+xⱼ) are each a linear transformation that is a sum of (i) a product between a respective weight matrix and a corresponding block input and (ii) the block input.

As described above, prior to using the neural network, the system trains the neural network to determine the values of the one or more learned parameters that can define weights for the block input, initial block output, linear transformations, etc.

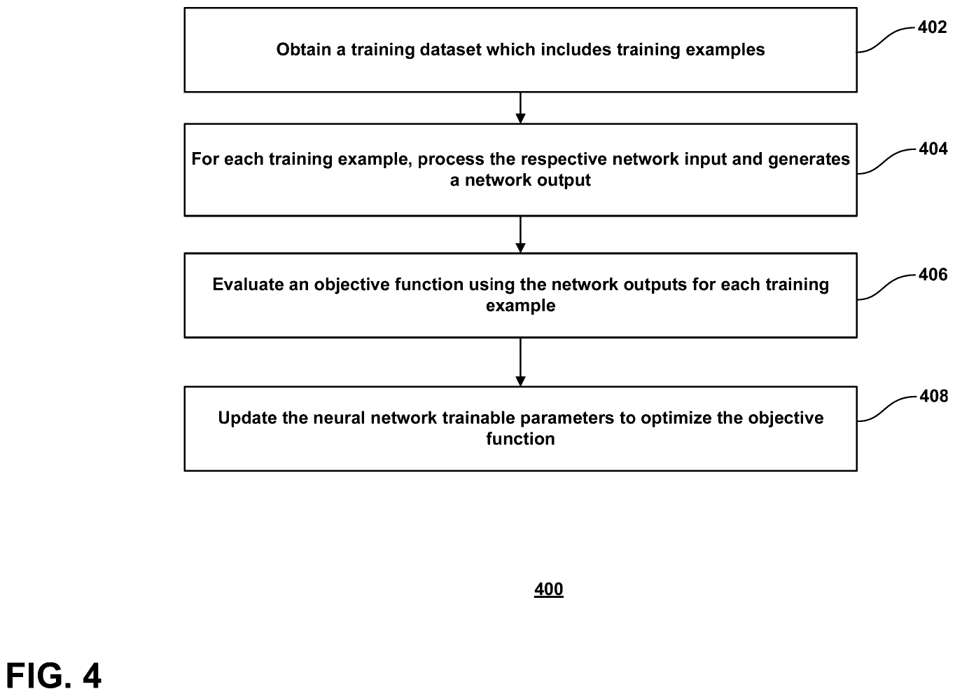

FIG. 4 is a flow diagram of an example process 400 for training a neural network to generate network output for network input. For convenience, the process 400 will be described as being performed by a system of one or more computers located in one or more locations. For example, a neural network system, e.g., the neural network system 100 of FIG. 1, appropriately programmed in accordance with this specification, can perform the process 400.

The system or another training system trains the neural network by repeatedly updating the learnable parameters of the neural network using a training dataset. That is, the system can repeatedly perform the following described example process using training examples that each include respective network inputs, and respective target network outputs, to train a neural network from scratch, i.e., train from randomly initialized parameters, or fine-tune, i.e., further train. The learnable parameters of the neural network include, for some or all layer blocks in a sequence of layer blocks, one or more learnable parameters of a LAuReL and the parameters of a learnable non-linear transformation.

In particular, the system obtains a training dataset which includes training examples (step 402). The system can receive the training dataset from any of a variety of appropriate sources, e.g., a user, another system, system data repository, and so on.

Generally, the system determines a plurality of training examples from the training dataset that each include a respective network input, and respective target network output.

The system, for each training example, processes the respective network input and generates a network output (step 404).

That is, the system generates network output for each training example by processing at least the network input associated with the training example using the neural network (e.g., as described above in example process 200 and example process 300 using a neural network that includes a sequence of one or more layer blocks, where some or all of the layer blocks include a LAuReL and learned non-linear transformation).

The system evaluates an objective function using the network outputs for each training example (step 406).

The objective function can include a loss for each training example and any additional regularization terms to improve neural network generalization.

One example loss function to compute the loss for a training example is the squared error loss function associated with the training example target network output and respective network output. More specifically, for this example, the squared error loss is the square of the difference of the generated network output with the respective target network output. For this example, an example objective function can be the mean squared error, i.e., the mean of the squared error loss for all training examples.

Another example loss function to compute the loss for a training example is the log loss associated with the training example target network output and respective network output. More specifically, for this example, the log loss is negative probability of the correct output (e.g., negative probability of the correct class for classification task, or the sum of the negative probabilities of selecting the correct token from a vocabulary for each token in sequence of tokens). For this example, an example objective function can be the mean log loss, i.e., the mean of the log loss for all training examples.

The system updates the neural network trainable parameters to optimize the objective function (step 408).

For example, the system updates learnable parameters that include, for each layer block that includes a LAuRel and learned non-linear transformation, the one or more learnable parameters of the LAuReL and parameters of the learnable non-linear transformation.

The system can update the neural network trainable parameters to optimize the objective in any variety of ways, e.g., gradient based method, evolutionary algorithm-based method, Bayesian optimization, grid search, etc.

For example, the system can optimize the objective function by minimizing the loss of one or more training examples described above using any of a variety of gradient descent techniques (e.g., batch gradient descent, stochastic gradient descent, or mini-batch gradient descent) that include the use of a backpropagation technique to estimate the gradient of the loss with respect to neural network learnable parameters and to update the learnable parameters accordingly.

Generally, the system repeats the above steps (404-408) until one or more criteria are satisfied (e.g., the system performs a pre-determined number of iterations, the updates to the learning parameters no longer exceed a pre-determined magnitude of change, a metric regarding a validation dataset exceeds a pre-determined value, and so on).

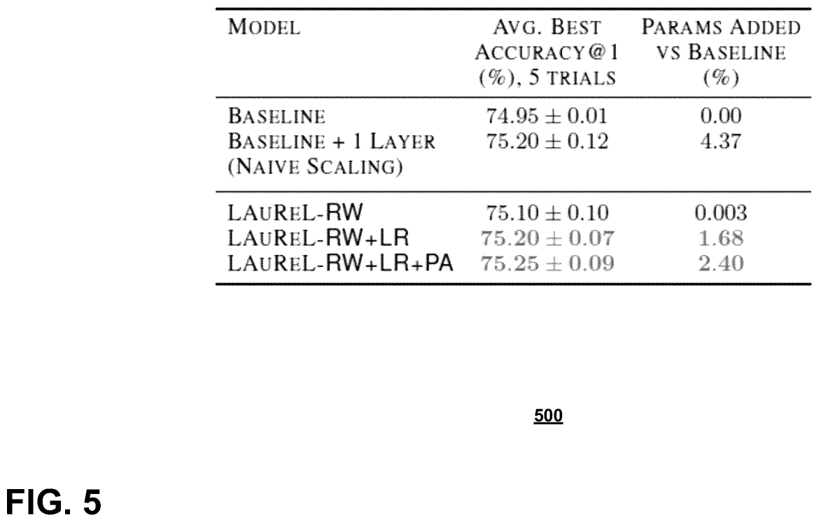

FIG. 5 is an example 500 of the performance of the described techniques.

More specifically, example 500 shows the performance of the described techniques (i.e., LAuReL−RW, LAuReL−RW+LR, and LAuReL−RW+LR+PA) and conventional techniques (i.e., BASELINE and BASELINE+1 LAYER) for image classification on the ImageNet-1K dataset summarized under the “AVG. BEST ACCURACY @ 1(%), 5 TRIALS” column in terms of percentage of how often a neural network's top class prediction is correct with error bars determined through five evaluations of the same dataset using five instances of trained neural networks using the same neural network architecture but using different initial starting learnable parameter values. Example 500 also shows the percentage of additional parameters relative to the BASELINE conventional technique each technique requires.

The BASELINE conventional techniques refers to the Resnet-50 neural network as described in arXiv: 1512.03385; BASELINE+1 LAYER refers to adding one additional fully connected layer to each layer block of the Restnet-50 neural network; LAuReL−RW refers to using the ResNet-50 neural network but replacing the residual connection layers in each layer block with LAuRel according to the described techniques when the one or more parameters include a first parameter that defines the respective weight for the block input and a second parameter that defines the respective weight for the initial block output; LAuReL−RW+LR refers to the previous LAuReL−RW described technique but further including a linear transformation applied to block input and combined with the initial block output, where the linear transformation is defined to be a low rank matrix that is the product of two matrices; LAuReL−RW+LR+PA refers to the previous LAuReL−RW+LR described technique but further including combining the initial block output for the particular layer block with the block input and the respective block inputs of one or more preceding blocks that precede the particular layer block in accordance with the one or more learned parameters to generate the block output for the particular layer block.

In particular, example 500 shows that the techniques that correspond to the described techniques of this specification all improve the performance of the neural network for performing an image classification task while using few extra parameters. LAUREL−RW provides a significant boost with negligible extra parameters. Additionally, LAUREL−RW+LR and LAUREL−RW+LR+PA meet and beat the naive scaling baseline while using 2.6× and 1.82× fewer parameters. The LAUREL−RW version of the described techniques results in an improvement of 0.15% on average with only 0.003% extra parameters, which is essentially negligible. The LAUREL−RW+LR version with low rank matrices that each have a rank of 16 and define a weight matrix for the linear transformation achieve an accuracy of 75.20% while adding only 1.68% extra parameters; this matches the performance of the BASELINE+1 LAYER technique, while using 2.6× fewer extra parameters. Additionally, the LAURELRW+LR+PA version improves the accuracy to 75.25% while still using 1.82× fewer extra parameters than the BASELINE+1 LAYER technique, demonstrating that the described techniques (i.e., LAUREL) is superior to naively scaling the neural network.

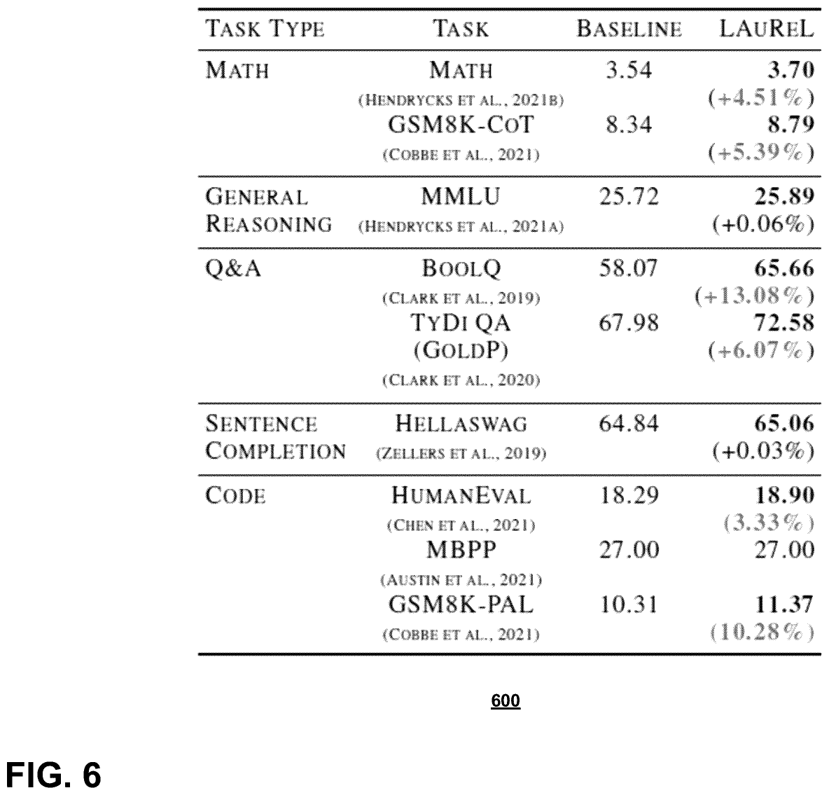

FIG. 6 is an example 600 of the performance of the described techniques.

More specifically, example 600 shows the performance of the described techniques (i.e., LAuReL) and conventional techniques (i.e., BASELINE) for various machine learning task types (i.e., MATH, which is solving math word problems or multiple choice questions; GENERAL REASONING, which is solving general reasoning across multiple choice tasks; Q&A, which is answering questions that have binary choices for answers or answering open ended questions in multiple languages; SENTENCE COMPLETION, which is completing given sequences of natural language; and CODE, which is evaluating or generating programming code). BASELINE refers to a 1 billion parameter decoder only neural network model based on the Transformer architecture pretrained from scratch using a pre-training mixture consisting of only text data which included webpages, books, code, translations, and other text data. LAuReL refers to the same training and neural network model as BASELINE does but with the residual layers of the decoder only neural network being replaced with LAuRel layers (i.e., layers that use the described techniques). The performance scores using the techniques of BASELINE and LAuReL for various task types are listed under the columns labeled BASELINE and LAuReL with task-specific evaluation metrics (where higher is better for each task type and task combination). Additionally, the relative percent difference in performance of LAuReL with respect to the BASELINE is outline in parathesis underneath the performance of LAuReL.

In particular, example 600 shows that the described techniques (i.e., LAUREL) outperforms the BASELINE for all the task types and tasks except on the MBPP dataset for code generation where it was neutral. These improvements were achieved with only 0.012% extra parameters and nearly no increase in latency.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., α machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a network input; and
processing the network input using a neural network to generate a network output for the network input, wherein the neural network comprises a sequence of layer blocks, and wherein processing the network input comprises, for each layer block, processing a respective block input for the layer block using the layer block to generate a block output for the layer block, wherein, for the first layer block in the sequence, the respective block input is the network input or an input derived from the network input and, for each subsequent block in the sequence, the respective block input is the block output for the preceding layer block in the sequence, and wherein processing a respective block input for the layer block using the layer block to generate a block output for the layer block comprises, for a particular layer block:
processing the block input for the particular layer block through a learned non-linear transformation to generate an initial block output for the particular layer block; and
combining the initial block output for the particular layer block with at least the block input in accordance with one or more learned parameters to generate the block output for the particular layer block.

2. The method of claim 1, wherein processing the network input further comprises:
processing the block output for a last layer block in the sequence using an output neural network head to generate the network output.

3. The method of claim 1, wherein the one or more learned parameters define respective weights for the block input and for the initial block output and wherein combining the initial block output for the particular layer block with at least the block input in accordance with one or more learned parameters to generate the block output for the particular layer block comprises:
determining a weighted sum of the initial block output for the particular layer block and the block input in accordance with the respective weights.

4. The method of claim 3, wherein the one or more parameters include a first parameter that defines the respective weight for the block input and a second parameter that defines the respective weight for the initial block output.

5. The method of claim 3, wherein the one or more parameters are a single parameter that defines both the respective weight for the block input and the respective weight for the initial block output.

6. The method of claim 1, wherein the one or more learned parameters define a linear transformation, and wherein combining the initial block output for the particular layer block with at least the block input in accordance with one or more learned parameters to generate the block output for the particular layer block comprises:
determining a combination of(i) the initial block output and (ii) an output of the linear transformation applied to the block input.

7. The method of claim 6, wherein the combination is a sum.

8. The method of claim 6, wherein the linear transformation is a product between a weight matrix and the block input and the one or more learned parameters define the entries of the weight matrix.

9. The method of claim 6, wherein the linear transformation is a sum of(i) a product between a weight matrix and the block input and (ii) the block input, the weight matrix is a low rank matrix that is a product between a first matrix and a second matrix, and the one or more learned parameters comprise the entries of the first and second matrices.

10. The method of claim 1, wherein combining the initial block output for the particular layer block with at least the block input in accordance with one or more learned parameters to generate the block output for the particular layer block comprises:
combining the initial block output for the particular layer block with the block input and respective block inputs of one or more preceding blocks that precede the particular layer block in the sequence in accordance with the one or more learned parameters to generate the block output for the particular layer block.

11. The method of claim 10, wherein the one or more learned parameters define respective weights to be applied to the initial block output, the block input, and the respective block inputs of one or more preceding blocks, and wherein combining the initial block output for the particular layer block with the block input and respective block inputs of one or more preceding blocks that precede the particular layer block in the sequence in accordance with the one or more learned parameters to generate the block output for the particular layer block comprises:
determining a weighted sum of(i) the initial block output for the particular layer block, (ii) a first input derived from the block input, and (iii) a respective second input derived from each of the respective block inputs of one or more preceding blocks in accordance with the respective weights.

12. The method of claim 11, wherein the respective weight for the initial block output is a fixed value.

13. The method of claim 12, wherein the fixed value is one.

14. The method of claim 11, wherein the first input derived from the block input is the block input.

15. The method of claim 11, wherein the respective second input derived from each of the respective block inputs of one or more preceding blocks is the respective block input of the one or more preceding blocks.

16. The method of claim 11, wherein the first input derived from the block input is an output of a first linear transformation applied to the block input.

17. The method of claim 16, wherein the set of one or more learned parameters comprises parameters that define the first linear transformation.

18. The method of claim 16, wherein the respective second input derived from each of the respective block inputs of one or more preceding blocks is an output of a respective second linear transformation applied to the respective block input of the one or more preceding blocks.

19. The method of claim 18, wherein the set of one or more learned parameters comprises parameters that define the respective second linear transformations.

20. The method of claim 18, wherein the first linear transformation and the respective second linear transformations are each a linear transformation that is a sum of(i) a product between a respective weight matrix and a corresponding block input and (ii) the block input, and wherein the respective weight matrix is a low rank matrix that is a product between a respective first matrix and a respective second matrix.

21. The method of claim 1, wherein the learned non-linear transformation comprises a multi-layer perceptron (MLP).

22. The method of claim 1, wherein the learned non-linear transformation comprises one or more convolutional layers.

23. The method of claim 1, wherein the learned non-linear transformation comprises one or more attention heads.

24. The method of claim 23, wherein the one or more attention heads apply cross-attention.

25. The method of claim 23, wherein the one or more attention heads apply self-attention.

26. The method of claim 1, wherein the learned non-linear transformation comprises one or more recurrent layers.

27. A system comprising one or more computers and one or more storage devices storing instructions that when executed by the one or more computers cause the one more computers to perform operations, the operations comprising:
obtaining a network input; and
processing the network input using a neural network to generate a network output for the network input, wherein the neural network comprises a sequence of layer blocks, and wherein processing the network input comprises, for each layer block, processing a respective block input for the layer block using the layer block to generate a block output for the layer block, wherein, for the first layer block in the sequence, the respective block input is the network input or an input derived from the network input and, for each subsequent block in the sequence, the respective block input is the block output for the preceding layer block in the sequence, and wherein processing a respective block input for the layer block using the layer block to generate a block output for the layer block comprises, for a particular layer block:
processing the block input for the particular layer block through a learned non-linear transformation to generate an initial block output for the particular layer block; and
combining the initial block output for the particular layer block with at least the block input in accordance with one or more learned parameters to generate the block output for the particular layer block.

28. One or more computer storage media storing instructions that when executed by one or more computers cause the one more computers to perform operations, the operations comprising:
obtaining a network input; and
processing the network input using a neural network to generate a network output for the network input, wherein the neural network comprises a sequence of layer blocks, and wherein processing the network input comprises, for each layer block, processing a respective block input for the layer block using the layer block to generate a block output for the layer block, wherein, for the first layer block in the sequence, the respective block input is the network input or an input derived from the network input and, for each subsequent block in the sequence, the respective block input is the block output for the preceding layer block in the sequence, and wherein processing a respective block input for the layer block using the layer block to generate a block output for the layer block comprises, for a particular layer block:
processing the block input for the particular layer block through a learned non-linear transformation to generate an initial block output for the particular layer block; and
combining the initial block output for the particular layer block with at least the block input in accordance with one or more learned parameters to generate the block output for the particular layer block.
